(19) United States
(12) Patent Application Publication
(10) Pub. No.: US 2013/0232093 A1
(43) Pub. Date: Sep. 5, 2013

(54) IMPACT ANALYSIS SYSTEMS AND METHODS

(71) Applicants: Latha Ganeshan, Johns Creek, GA (US); Parsh Wanath, Johns Creek, GA (US)

(72) Inventors: Latha Ganeshan, Johns Creek, GA (US); Parsh Wanath, Johns Creek, GA (US)

(21) Appl. No.: 13/411,522

(22) Filed: Mar. 3, 2012

(51) Int. Cl. G06F 15/18; G06Q 40/00

(52) U.S. Cl. 706/12; 705/7.28

(57) ABSTRACT

In one exemplary implementation, a system includes an input/output interface for receiving first, second, and third portions of data from first, second and third nodes respectively. The three portions of data contain three respective metrics. The system further includes a processor that is used to generate a primary traversal graph for analyzing interactions between the first, second and third nodes. The analyzing includes designating the first node as an independent node upon detecting that the first metric is an independent metric, and designating a combination of at least the second and third nodes as an integrated node upon detecting a circular interdependency that includes the second and third metrics. The processor is further used to generate a secondary traversal graph for analyzing interactions between the independent node and the integrated node and to determine a cost impact associated with the independent node and/or the integrated node.

### DESCRIPTION OF THE RELATED ART

Deriving useful information from large amounts of non-homogenous data often presents unique hurdles and challenges. Some of these challenges may be overcome by using a human being to examine the data and detect certain relationships or irregularities that may be present in the data. However, this type of manual processing can only be performed upon a limited quantity of data and is often inefficient as far as large amounts of homogenous or repetitive data processing is concerned. As is known, in most cases, processing of large amounts of homogenous data, or repetitive calculations, is better handled by a computer than by a human being.

However, computer-based data processing suffers from certain limitations when the data is non-homogeneous in nature or contains ambiguous content. Not only do many computer programs fail to effectively identify certain types of ambiguities, but may further fail to figure out a way to effectively resolve these ambiguities even when such ambiguities have been identified.

### SUMMARY

According to a first aspect of the disclosure, a system includes an input/output interface and a processor. The input/output interface is operable to receive from a first node, a first portion of data comprising a first metric; receive from a second node, a second portion of data comprising a second metric; and receive from a third node, a third portion of data comprising a third metric. The processor is operable to use the first, second and third portions of data to generate a primary traversal graph for analyzing interactions between the first, second and third nodes. The processor is further operable to use the primary traversal graph to analyze the received first portion of data, and upon detecting that the first metric is an independent metric, designate the first node as an independent node; and to use the primary traversal graph to analyze the received second and third portions of data, and upon detecting a circular interdependency between the second and third metrics designate a combination of the second and third nodes as an integrated node. The processor also generates a secondary traversal graph for analyzing interactions between the independent node and the integrated node, and uses the secondary traversal graph to determine a cost impact associated with at least one of the independent node or the integrated node.

According to a second aspect of the disclosure, a computer-readable storage medium has stored thereon computer-executable instructions for performing the steps of: analyzing a first portion of data comprising a first metric and determining therefrom, that the first metric is an independent metric; using the independent metric to determine a first impact parameter; analyzing a second portion of data comprising a plurality of metrics and detecting a circular interdependency in the plurality of metrics; based upon the circular interdependency, designating the plurality of metrics as an integrated metric; using the integrated metric to determine a second impact parameter; and combining the first impact parameter and the second impact parameter to determine a first cost impact.

According to a third aspect of the disclosure, a method includes the steps of receiving in a computer, a first portion of data comprising a first metric; receiving in the computer, a second portion of data comprising a second metric; and receiving in the computer, a third portion of data comprising a third metric; analyzing the received first portion of data and determining that the first metric is an independent metric; analyzing the received second and third portions of data and detecting a circular interdependency between the second and third metrics; upon detecting the circular interdependency, designating a combination of at least the second and third metrics as an integrated metric; using the independent metric to determine a first impact parameter; using the integrated metric to determine a second impact parameter; and combining the first and second impact parameters to determine a first cost impact.

Further aspects of the disclosure are shown in the specification, drawings and claims below.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts, or descriptively similar parts, throughout the several views and embodiments.

FIG. 1 shows a few examples of spatially separated metrics and events from which metrics may be retrieved for processing in an impact analysis system in accordance with the invention.

FIG. 2 shows a first exemplary environment in which exemplary spatially separated events have associated metrics that may be retrieved and processed by an impact analysis system in accordance with the invention.

FIG. 3 shows a second example environment in which a few exemplary spatially separated events have associated metrics that may be retrieved and processed by an impact analysis system in accordance with the invention.

FIG. 4 shows a third example environment in which a few exemplary spatially separated metrics, as well as events having associated metrics, that may be retrieved and processed by an impact analysis system in accordance with the invention.

FIG. 5 shows a few examples of events that are separated from each other in time and having associated metrics that may be retrieved and processed by an impact analysis system in accordance with the invention.

FIG. 6 shows a first exemplary communication network that may be used to collect data from a variety of sources for processing in an impact analysis system in accordance with the invention.

FIG. 7 shows a second exemplary communication network that may be used to collect data from a variety of sources for processing in an impact analysis system in accordance with the invention.

FIG. 8 shows an exemplary network of computers that are used to implement a method of impact analysis in accordance with the invention.

FIG. 9 shows a primary traversal graph corresponding to the exemplary network of computers shown in FIG. 8.

FIG. 10 shows a secondary traversal graph generated after analysis of the primary traversal graph shown in FIG. 9.

FIG. 11 shows a flow chart indicating various steps that may be implemented in accordance with the invention for generating the secondary traversal graph shown in FIG. 10.

FIGS. 12A-B show a flow chart indicating various steps that may be implemented for calculating a cost impact in accordance with the invention.

FIG. 13 shows a table that lists costs associated with various individual nodes shown in FIGS. 9 and 10.

FIG. 14 shows an exemplary computer system that may be used to implement a system and method of impact analysis in accordance with the invention.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. For example, it will be understood that terminology such as nodes, strong nodes, algorithms, interdependency, circular interdependency, cost, and cost impact are used herein as a matter of convenience for description purposes and should not be interpreted in a limiting manner.

Specifically, the word “example” as used herein (in whatever context) is intended to be non-exclusionary and non-limiting in nature. Specifically, the word “exemplary” indicates one among several examples, and it must be understood that no special emphasis is intended or suggested for that particular example. A person of ordinary skill in the art will understand the principles described herein and recognize that these principles can be applied to a wide variety of applications and situations, using a wide variety of tools, processes, and physical elements. Furthermore, when a list of exemplary items is provided (by using the words “such as” or “for example”) it must be understood that the list is a non-exhaustive list and may include several more exemplary items.

It must be further understood that the word “cost” as used herein should not be interpreted solely in terms of monetary units (a dollar value, for example) but should be understood to represent a variety of parameters in a variety of embodiments. A few non-limiting examples include a cost in terms of human life, a cost in a cause-and-effect scenario, a cost indicated in terms of a statistical probability of an occurrence of an event, or a cost in terms of productivity (man-hours for example).

It must also be understood that the word “metric” as used herein encompasses a wide variety of numerical, non-numerical, variable and fixed parameters (such as for example, fixed, variable and/or statistical monetary values); fixed, variable, and/or predicted head counts; trend results of an opinion poll; odds of an event occurrence; or odds in a betting/wager scenario.

The various embodiments generally describe systems and methods related to processing data retrieved from a variety of data sources in order to determine a variety of cost impacts. These data sources may be separated from each other in space (for example, data may be stored in a variety of computers distributed throughout the world), and/or may be separated from each other in time (for example, individual causal events may have occurred at different times over several years). Furthermore, the retrieved data may be non-homogeneous in nature. For example, data retrieved from a first source may be different from data retrieved from another source.

The various cost impacts are generally determined by using an algorithm that not only provides for the identification of unambiguous cost metrics in the retrieved data but also provides for the identification of certain ambiguous cost metrics. When such ambiguous cost metrics are identified, the algorithm further provides for selectively combining two or more of these metrics so as to form a unified element (referred to herein in certain embodiments, as an integrated metric). The unified element is more unambiguous in nature and is typically characterized by a definable cost metric that can be processed by a computer.

It may be pertinent at this time to elaborate upon the phrase “circular interdependency,” which is used herein, generally in the context of processing two or more ambiguous metrics.

A database structure is used as a first example environment for purposes of explaining the phrase. In this particular example, a first numerical value contained in cell A1 of a spreadsheet is determined on the basis of adding 7 to a second numerical value contained in cell B1 of the spreadsheet. However, the second numerical value contained in cell B1 is determined by adding 3 to the first numerical value contained in cell A1 of the spreadsheet. As can be appreciated, this recursive relationship, which is referred to herein as a “circular interdependency,” leads to an ambiguous and undesirable condition wherein the values (metrics) contained in cells A1 and B1 are numerically indeterminate.

To provide another example, let it be assumed that the price of shares (metric) of company A is determined by the performance of company B. In turn, the price of shares of company B is determined by the performance of company A, thereby creating a recursive and ambiguous stock price scenario, which may be described as having been created as a result of “circular interdependency.”

To provide yet another example, consider a situation wherein fulfillment of a sales order by a sales department of a large company requires data input from the marketing department (for example, information on quantity-based sales discounts). The marketing department in turn requires availability information from the factory (production, inventory etc) to ensure that delivery of certain quantities of the product can be carried out. However, the factory in turn requires sales information from the sales department in order to predict and prepare for appropriate production, inventory, and delivery commitments. This “circular interdependency” between the various departments leads to ambiguity and prevents the generation of unambiguous metrics that can be used to fulfill the sales order with a predictable and verifiable commitment.

In view of the examples described above, it should be understood that the algorithm, as used herein in accordance with the invention, identifies one or more circular interdependencies that may exist in various situations, and provides a solution to address and overcome certain shortcomings associated with these circular interdependencies.

It will be understood that the metrics used by impact analysis system 100, which is described below, is not limited to data that contains circular interdependencies, but may include other forms of data as well. Two other types of such data are referred to herein as “interdependent” data and “independent” data.

Interdependent data includes certain metrics having one or more interdependencies that are not circular interdependencies. In other words, such metrics can be processed by impact analysis system 100 in an unambiguous manner. This aspect may be better understood by using an example, wherein the dividend paid out to stockholders is dependent upon sales performance, and the sales performance in turn is determined by the type of management selected by the stock holders. As can be understood the interaction of the various metrics (dividend, sales performance, type of management, stockholders etc) is interdependent but not in a circularly interdependent manner.

In contrast to interdependent data, which may or may not be circularly interdependent, independent data is unambiguous data that may be readily used for processing in impact analysis system 100. One example of independent data is data retrieved solely from a database containing pricing information for various types of products and services.

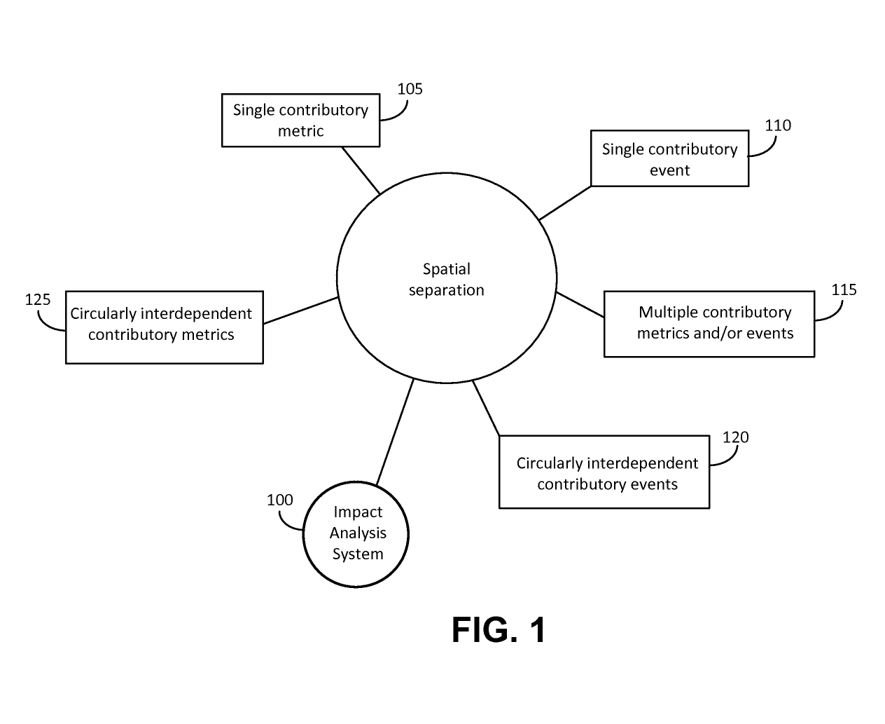

Attention is now drawn to FIG. 1, which shows a few examples of spatially separated metrics, and events from which metrics may be retrieved, for processing in an impact analysis system 100 in accordance with the invention. While these events and metrics are illustrated in this figure at a somewhat abstract level, the nature of these events and metrics may be understood in more detail from the description below pertaining to a few exemplary applications shown in additional figures.

Single contributory metric 105 represents a source of data that is relatively unambiguous and may be referred to in this case, as independent data. For example, single contributory metric 105 may be the sales price of a piece of software. This pricing information may be retrieved by impact analysis system 100 from a database, for example, and used for generating an invoice.

Single contributory event 110 represents an event from which relatively unambiguous metrics may be derived for processing in impact analysis system 100. For example, single contributory event 110 may pertain to issuing of a license to operate a piece of software. The metric associated with this event may be a license fee that is levied upon a user of the software.

Multiple contributory metrics and/or events 115 represents a variety of metrics and/or events from which metrics may be derived and retrieved by impact analysis system 100. The retrieved metrics may include independent metrics, interdependent metrics, and/or circularly interdependent metrics.

Circularly interdependent contributory events 120 represents a source from which one or more circularly interdependent metrics may be obtained.

Circularly interdependent contributory metrics 125 represents a source of data, such as a database in which is stored one or more sets of circularly interdependent metrics. When these circularly interdependent metrics are retrieved by impact analysis system 100, an algorithm (not shown) that is contained in impact analysis system 100 has to not only identify these circularly interdependent metrics from amongst a number of metrics retrieved from various sources that may or may not contain interdependencies, but must further resolve the ambiguity present in these metrics. The manner in which the ambiguity is resolved is described below in more detail using other figures.

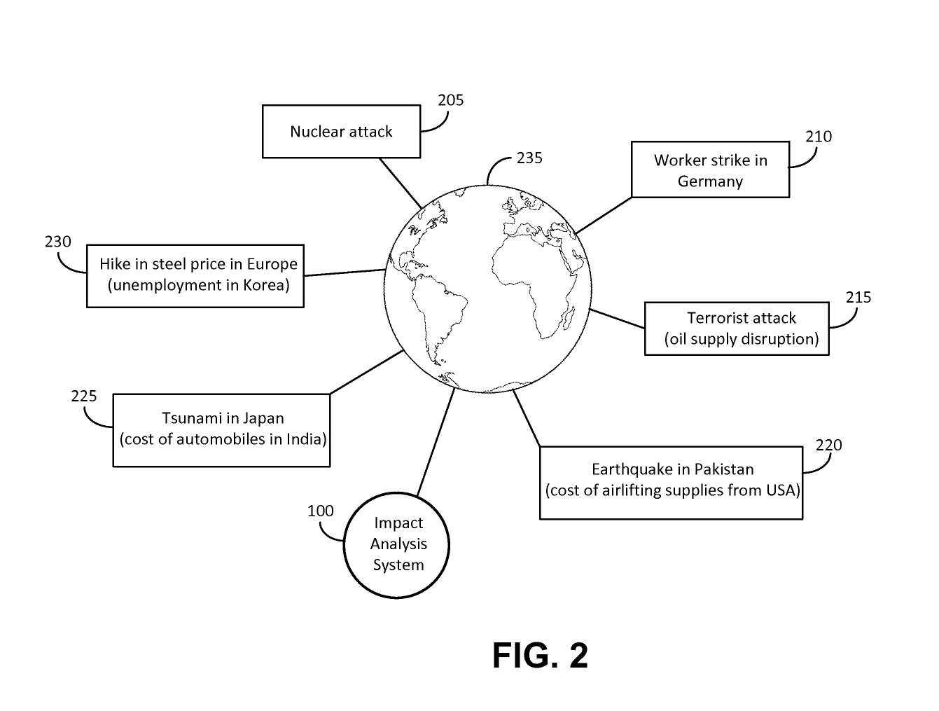

Attention is next drawn to FIG. 2, which shows a first exemplary environment in which spatially separated events have associated metrics that may be retrieved and processed by an impact analysis system 100 in accordance with the invention. In this particular example, the events are shown as occurring in a global environment represented by the symbolic world 235.

Nuclear attack 205 is a first exemplary event that may be characterized by using a variety of metrics, such as for example: a monetary loss value, a loss value in terms of human lives, an outrage rating, a world-wide support rating, a regional support rating, or statistics relating to the potential occurrence of similar events in this as well as other regions of the world.

Worker strike in Germany 210 is a second exemplary event that may be characterized by using a variety of metrics, such as for example: a monetary impact upon one or more European countries, a monetary impact upon the United States of America (USA), or a non-monetary impact (for example, an influence upon a political event occurring in Germany).

Terrorist attack 215 is a third exemplary event that may be characterized by using a variety of metrics, such as for example: a monetary impact based on oil supply disruption to one or more countries.

Earthquake in Pakistan 220 is a fourth exemplary event that may be characterized by using a variety of metrics, such as those disclosed above. One exemplary metric that is indicated in FIG. 2 as being associated with the earthquake event is the cost of airlifting supplies from USA to Pakistan.

Similarly, tsunami in Japan 225 may be characterized by using a variety of metrics, some of which are described above. One or more of these metrics may be used for example assess a cost impact on automobiles in India.

Hike in steel price in Europe 230 may be also characterized in various ways as disclosed above. The metrics associated with this event may be used, for example, to determine various parameters, such as, for example, a resultant unemployment level (head count, percentage value) in Korea, or a resultant drop in the gross domestic product (GDP) in India.

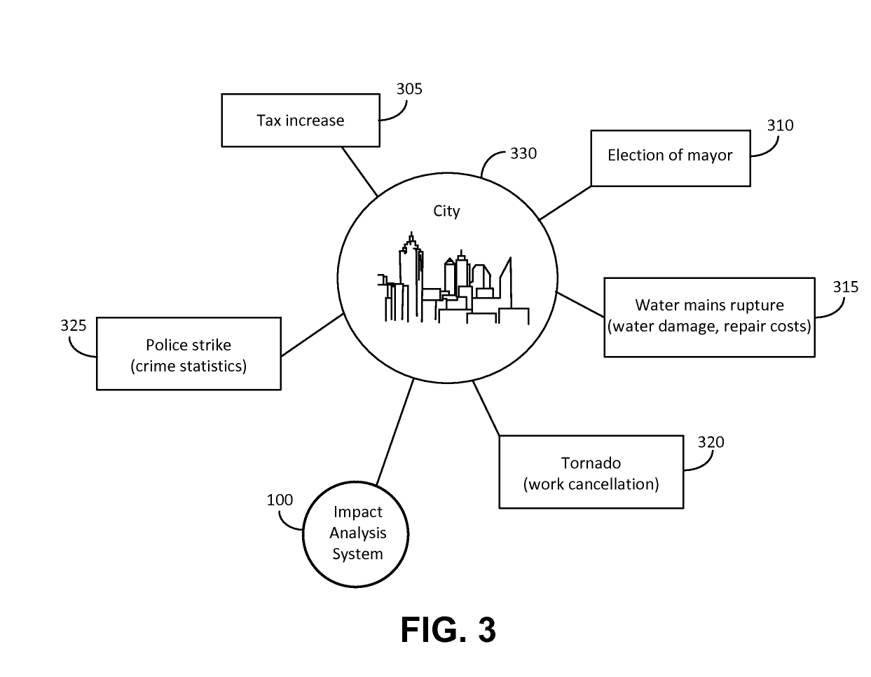

Attention is now drawn to FIG. 3, which shows a second exemplary environment in which spatially separated events have associated metrics that may be retrieved and processed by an impact analysis system 100 in accordance with the invention. In this particular example, the events are associated with a city 330.

Election of mayor 310 is a first exemplary event that may be associated with one or more independent, interdependent, and/or circularly interdependent metrics. For example, a first metric may be associated with a change in policy characterized in terms of a financial blueprint that is presented by the mayor outlining his/her plans for the next four years. As another example, a second metric may pertain to personal statistics (health, tax returns, family details, scandals, morals etc) of a potential candidate that the mayor may use to decide if the candidate is suitable for a particular position in the new administration.

Water mains rupture 315 is a second exemplary event that may be associated with one or more independent, interdependent, and circularly interdependent metrics. Such metrics may include parameters such as water damage estimates and/or repair costs.

Tornado 320 is a third exemplary event that may be associated with one or more independent, interdependent, and circularly interdependent metrics, such as for example, parameters associated with work cancellation in many offices and businesses.

Police strike 325 is a fourth exemplary event that may be associated with one or more independent, interdependent, and circularly interdependent metrics, such as for example, crime statistics.

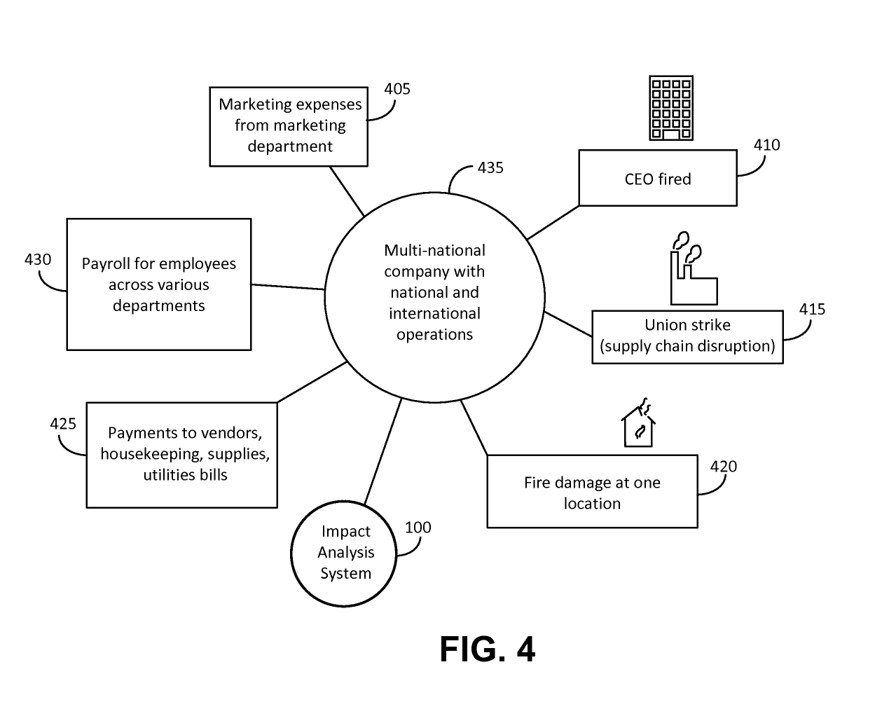

FIG. 4 shows a third exemplary environment in which spatially separated metrics as well as events having associated metrics that may be retrieved and processed by an impact analysis system 100 in accordance with the invention. In this particular example, the events are associated with a multi-national company 435 having multiple national and international operations.

The CEO firing event 410 at headquarters may be associated with one or more independent, interdependent, and circularly interdependent metrics, some of which can be understood in the context of the various examples provided above.

Union strike 415 and fire damage 420 may also be understood in the context of the various examples provided above.

Other metrics that may be retrieved and processed in impact analysis system 100 includes payments to vendors, housekeeping, supplies, utilities bills etc as shown in block 425, payroll for various employees as shown in block 430, and marketing expenses as shown in block 405.

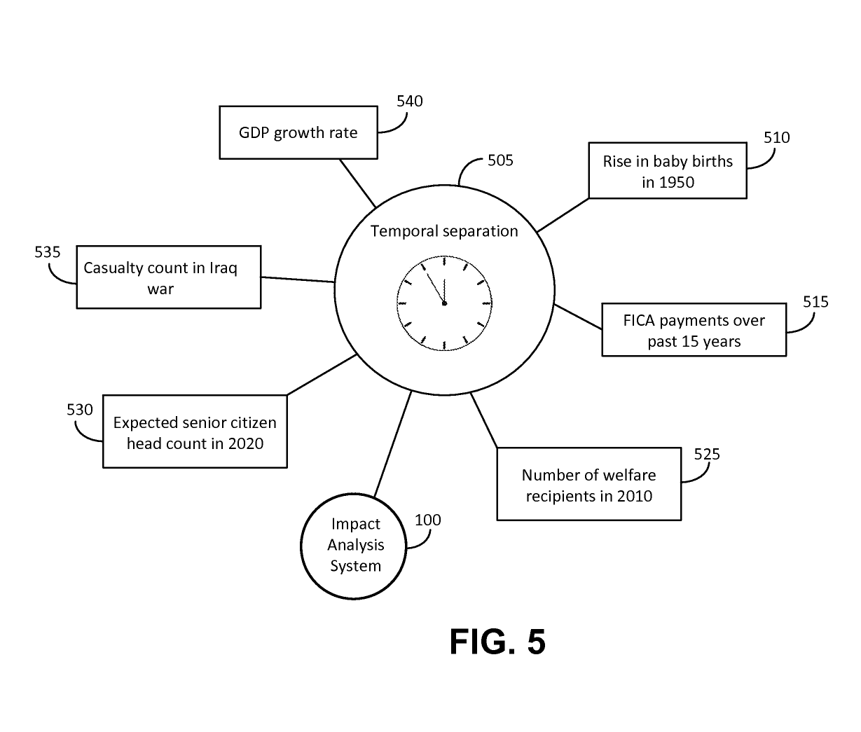

FIG. 5 shows a few examples of events that are separated from each other in time and having associated metrics that may be retrieved and processed by an impact analysis system 100 in accordance with the invention. Temporal separation is indicated symbolically by time symbol 505.

Block 510 indicates a rise in baby births in the year 1950. Metrics associated with this event may be retrieved by impact analysis system 100 and used to calculate an expected senior citizen head count in the year 2020 (as shown in block 530). The metrics retrieved from block 510 may include one or more independent, interdependent, and circularly interdependent metrics.

Federal Insurance Contributions Act (FICA) tax payments (indicated in block 515) may also be derived from various other events, such as, for example, the expected senior citizen head count in the year 2020 (block 530) and/or the GDP growth rate (block 540).

The effects of the casualty count in Iraq war (block 535) may impact various other events in the future. Metrics associated with this event may be retrieved by impact analysis system 100 and used to determine various monetary and non-monetary costs such as the expected senior citizen head count in the year 2020.

Similarly, the number of welfare recipients in the year 2010 (block 525) may impact the GDP growth rate (block 540) in various years current as well as future. Such cost impacts may be calculated in accordance with the invention using impact analysis system 100.

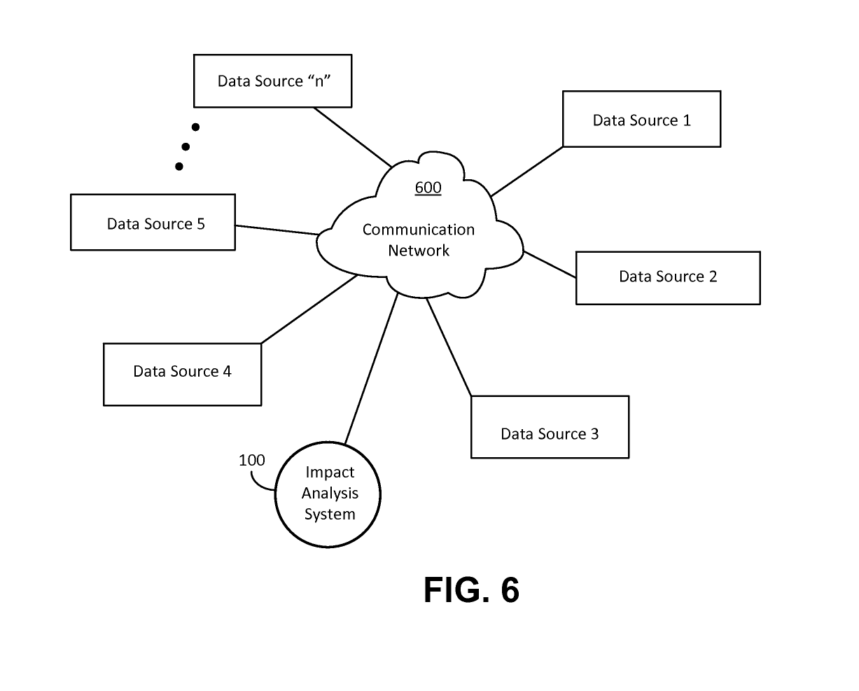

FIG. 6 shows a first exemplary communication network 600 that may be used to collect data from a variety of sources for processing in impact analysis system 100 in accordance with the invention.

Each of the data sources may be implemented in many different forms including data generating sources (such as one or more computers) and data storage sources (such as a disk storage system in which a database is stored). Appropriate exemplary computers for implementing each of the data generating/storage sources include general-purpose computers, dedicated computers, desktop computers, laptop computers, Personal Digital Assistants (PDAs), handheld computers, smart phones, server processors, client processors, or a combination thereof.

Each of the data sources may be implemented in a single computer or in multiple computers. Multiple computers may be distributed or centrally located, and may communicate via wireless links, hard-wired links, or a combination thereof. The interfaces used by one or more of the data sources to communicate with impact analysis system 100 via the network 600 may include any appropriate interface, such as a wireless interface, a wired interface, or a combination thereof.

Any of a wide variety of communications protocols may be used to communicate via the network 600, including both public and proprietary protocols, such as, for example, TCP/IP and Ethernet. Network 600 may include public portions (e.g., the Internet) as well as private portions (e.g., a residential Local Area Network (LAN)), or a combination thereof. The network 600 may be implemented using any one or more of a wide variety of conventional communications media including both wired and wireless media such as acoustic, RF, infrared and other wireless media.

In one exemplary embodiment, impact analysis system 100 uses a search engine (not shown) to retrieve data from the various data sources. The search engine may be executed via a web browser or a data processing system that may be incorporated into impact analysis system 100.

In another exemplary embodiment, impact analysis system 100 retrieves data from one or more of known data sources without using a search engine. This method may be employed for example in a secure computing environment such as a private network that is inaccessible to unauthorized users.

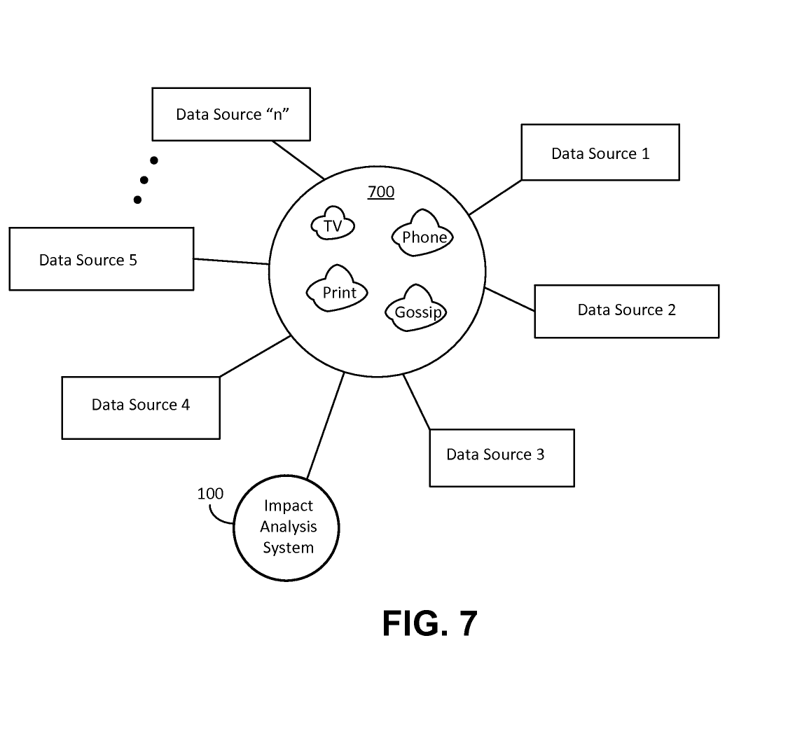

FIG. 7 shows a second exemplary communication network 700 that may be used to collect data from a variety of sources for processing in impact analysis system 100 in accordance with the invention. In this exemplary embodiment, the various data sources are not necessarily computers. For example, one or more of the data sources are human beings who transfer information to others via communication network 700 using a variety of media such as letters, emails, television, telephone calls, print media, gossip propagation, and Internet-based communications. The transferred information may be gathered in a variety of ways, such as for example, by telephone wiretapping, email monitoring, web page monitoring, reading newspapers/magazines, espionage, and watching television. The gathered information is then input into impact analysis system 100 in a variety of ways, including by the use of human computer operators.

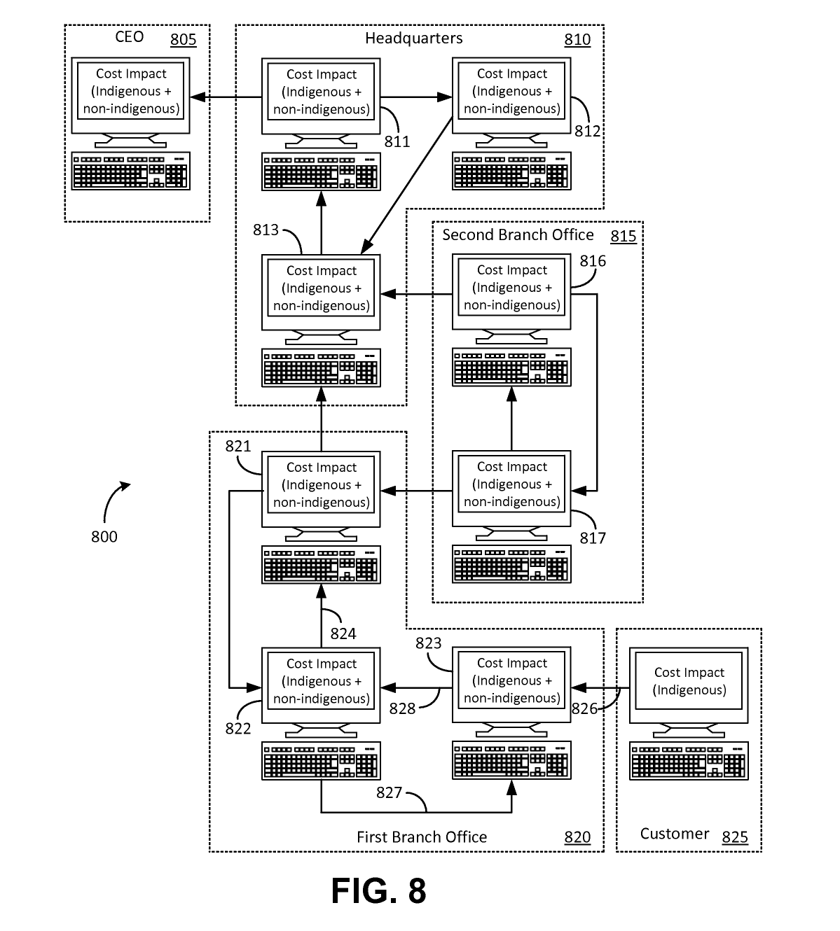

FIG. 8 shows an exemplary network 800 of computers that may be used to implement a method of impact analysis in accordance with the invention. The various computers are communicatively coupled to each other in various ways (including via communication networks 600 and 700 described above). The communicative coupling between the various computers is not shown in FIG. 8 so as to avoid distracting from the description below of certain inventive aspects. Furthermore, each of the computers may be alternatively referred to herein in certain contexts, as a “node.” This is done for purposes of describing certain data-related, cost-related, and impact-related aspects that are relevant to this embodiment. However, it will be understood that in various other embodiments, the word “node” may refer to other sources of data that have been described above using FIGS. 6 and 7.

In the exemplary embodiment shown in FIG. 8, the various computers are associated with various entities. Specifically, computer 805 is shown as symbolically representing a chief executive officer (CEO) of a company working out of a telecommuting location that is communicatively coupled to headquarters 810. Headquarters 810 contains multiple departments that are symbolically represented by computers 811, 812 ands 813. Similarly, a computer at a customer location 825 represents a customer entity. Customer location 825 is communicatively coupled to a first branch office 820, which contains multiple departments (symbolically represented by computers 821, 822 ands 823). First branch office 820 is communicatively coupled to headquarters 810 and to a second branch office 815, which also contains multiple departments that are symbolically represented by computers 816 and 817.

Each of the arrows shown in FIG. 8 indicates a cost impact, specifically a non-indigenous cost impact that is applied by one node upon another. For example, arrow 826 is indicative of a non-indigenous cost impact that is imposed by the node (customer) located in customer location 825 upon node 823 (sales team) of first branch office 820. This non-indigenous cost impact upon first branch office 820 may be characterized in a variety of ways, for example, a monetary amount spent by the sales team to service the customer, a head count of the sales team needed to service the customer, or the number of man hours spent on servicing the customer.

The various cost impacts imposed by inter-office departments upon each other, as well as imposed by intra-office divisions of the company upon each other, are indicated by various similar arrows.

Circular interdependency and cost impacts associated with the various entities of FIG. 8 will now be described in further detail. Let it be assumed that the CEO (represented by computer 805) has decided to carry out some austerity measures in view of the company having suffered some financial losses. As one of these measures, the CEO demands that the overall operating cost of the company be reduced to a certain target value. Headquarters 810 examines the target value and determines respective operating cost targets for the two branch offices. The respective operating cost targets are forward to the two branch offices.

The branch manager (represented by computer 821) at first branch office 820 receives the operating cost information and decides that the operating cost target can be met by standardizing all computers of first branch office 820 to a particular operating system. The branch manager passes on his decision to the sales manager (represented by computer 822) who in turn passes it on to the sales team (represented by computer 823).

The sales team obtains this managerial decision from the sales manager and responds by pointing out to the sales manager that none of the existing computers in the sales department support the recommended operating system. However, the sales team also provides further information that it would be possible to implement the recommended operating system by purchasing new computers. The sales manger receives this information from the sales team and passes it on to the branch manager. Naturally, the branch manager is unwilling to authorize a purchase of new computers as such a purchase would cause the operating cost target handed down by headquarters to be exceeded. This ambiguous situation in first branch office 820 may be interpreted as a circular interdependency.

The circular interdependency in first branch office 820 (as well as in other offices of the company) has an overall cost impact upon the company. Let it be assumed that the CEO wishes to determine this overall cost impact without directly assigning this task to any of his employees. In order to do so, the CEO uses computer 805 to retrieve information from all the other computers shown in FIG. 8.

The information may be retrieved in a variety of formats. For example, in one case, the retrieved information may be emails transmitted between the various personnel in first branch office 820 with reference to implementing the operating cost target. As another example, the retrieved information may be a spreadsheet stored in one or more of the other computers. As yet another example, the retrieved information may include personnel information such as headcount, payroll, job performance, annual reviews, or age information.

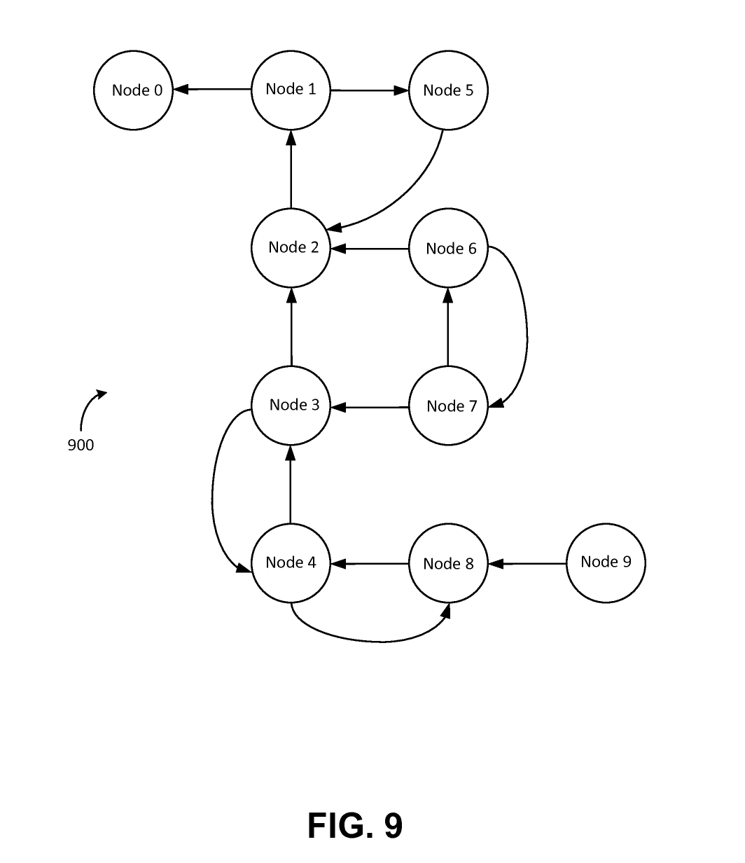

After retrieving the information from all the other computers, an impact analysis program in accordance with the invention is executed on computer 805. This program extracts one or more metrics contained in the retrieved information. For example, if a monetary impact analysis is to be carried out, the impact analysis program extracts metrics pertaining to monetary values and uses these values to generate a primary traversal graph, which is shown in FIG. 9.

The primary traversal graph 900 shown in FIG. 9 indicates each of the computers shown in FIG. 8 as a group of nodes interconnected to each other by arrows that represent cost-related interactivity between the various nodes. Attention is drawn to nodes 3, 4 and 8 corresponding to computers 821, 822 and 823 of FIG. 8, which have a circular interdependency per the scenario described above.

Primary traversal graph 900 may be used to detect one or more other such circular interdependencies. This detection may be carried out by selecting any node in primary traversal graph 900 and following a path defined by the arrows extending out of this node to one or more other nodes. If the path is a circular path, or in other words can start and end at the particular node, the nodes associated with the path are members of a circular interdependency.

To illustrate this process, let node 3 be a selected node. It can be observed that one arrow extends out of node 3 towards node 4. In turn, an arrow extends out of node 4 and into node 8. Node 8 is connected back to node 4 by an arrow, which is then extended from node 4 back to node 3. This circular path (node 3->node 4->node 8->node 4->node 3) is indicative of a circular interdependency.

It can also be observed that there are two smaller circular interdependencies inside this circular path. The first one is between nodes 3 and 4, and the second one is between nodes 4 and 8. Primary traversal graph 900 shows several other nodes that constitute circular interdependencies.

While a visual observation of primary traversal graph 900 may be used to detect various circular interdependencies, the impact analysis program executed on computer 805 (node 0) in accordance with the invention detects these one or more circular interdependencies by analyzing the various metrics derived from the information retrieved from the various computers.

(It may be pertinent to point out that the impact analysis program may be executed on any of the computers of FIG. 8 in order to analyze the cost impact at any of the individual nodes representative of these computers.)

The detection of the one or more circular interdependencies by the impact analysis program may be carried out as a first cycle of a multi-cycle operation incorporating one or more algorithms. For example, algorithms such as Kosaraju's algorithm, Gabow's algorithm, and Tarjan's algorithm may be employed in various embodiments.

Specifically, Tarjan's algorithm is generally known to persons of ordinary skill in the art in its generic form, and will therefore not be elaborated upon herein.

In a preferred embodiment of the invention, impact analysis system 100 uses a version of Tarjan's algorithm that is specially adapted for providing various functionalities such as, for example, the generation of a primary traversal graph from retrieved data, detection of one or more circular interdependencies, the generation of a secondary traversal graph, and determining of one or more cost impacts.

The primary traversal graph has been described above using FIG. 9. In contrast to the primary traversal graph, a secondary traversal graph may include an element referred to herein by various terms such as a “strong node” or an “integrated node.” A strong node is composed of two or more nodes having a circular interdependency.

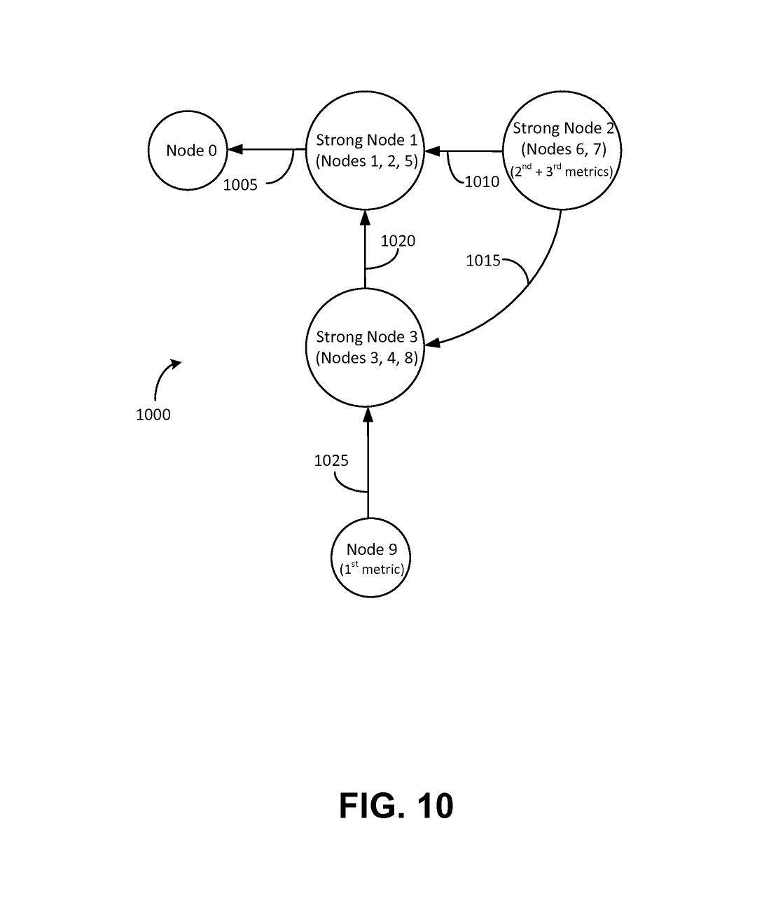

This aspect is illustrated in FIG. 10, which shows a secondary traversal graph 1000 containing three strong nodes and two independent nodes. Specifically, nodes 3, 4 and 8, which as described above, have a circular interdependency are grouped together as strong node 3. Nodes 1, 2 and 5, which also have a circular interdependency are grouped together as strong node 1, while nodes 6 and 7 are grouped together as strong node 2. Node 9 is an independent node that does not have any cost dependency from other nodes.

Referring first to strong node 2, each of the two constituent nodes 6 and 7 has certain associated cost impacts in a combined form. This combined cost impact is shared equally by two other nodes—strong node 1 and strong node 3.

Expressed in another way, strong node 3 bears a indigenous cost impact and a non-indigenous cost impact, where the non-indigenous cost impact is contributed by strong node 2 (arrow 1015) and independent node 9 (arrow 1025).

Strong node 1 also bears an indigenous cost impact and a non-indigenous cost impact, where the non-indigenous cost impact is contributed by strong node 2 (arrow 1010) and strong node 3 (arrow 1020).

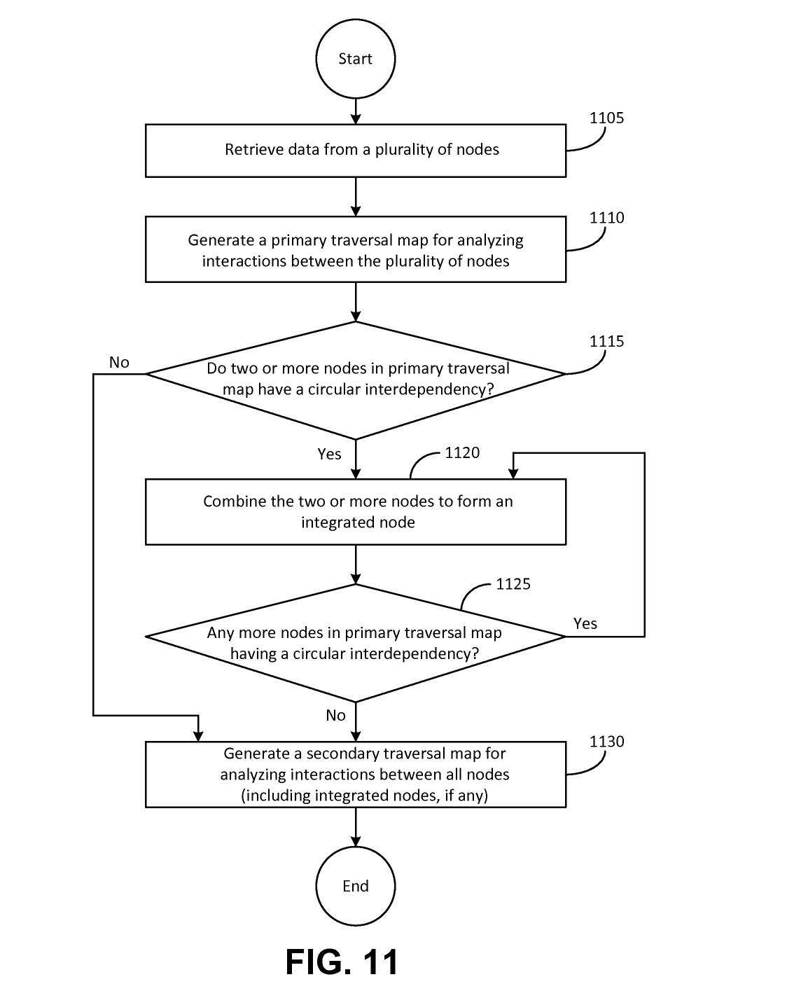

FIG. 11 shows a flow chart indicating various steps that may be implemented in accordance with the invention (using Tarjan's algorithm in one embodiment) for generating the secondary traversal graph shown in FIG. 10.

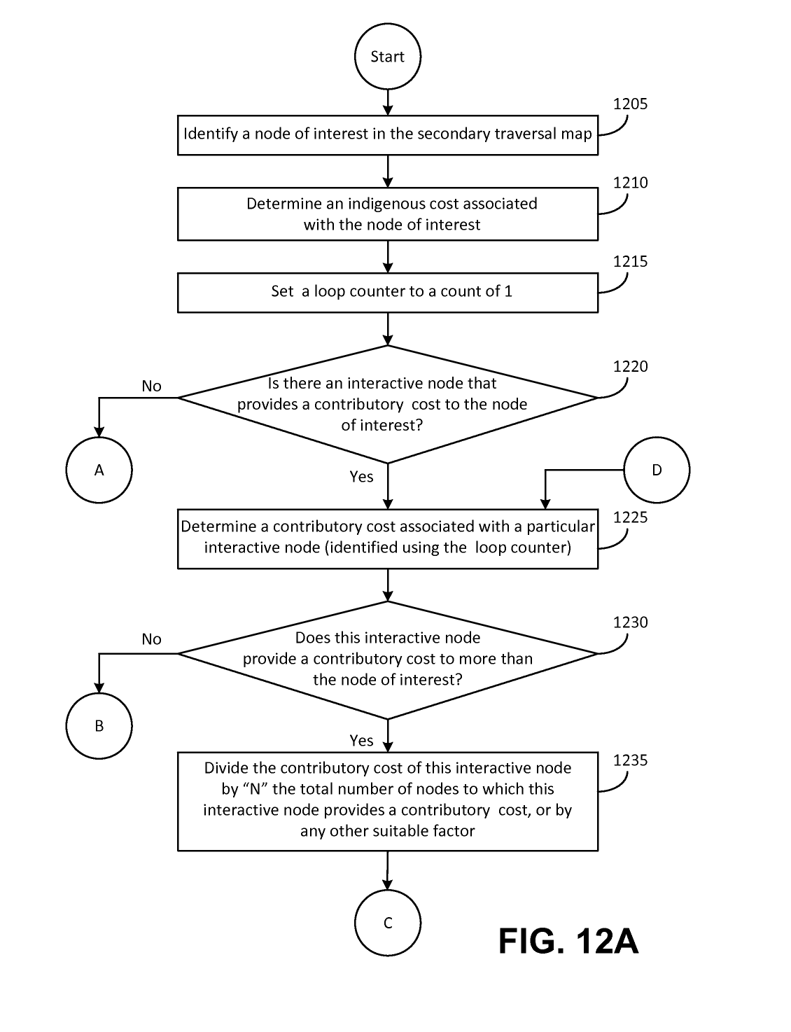

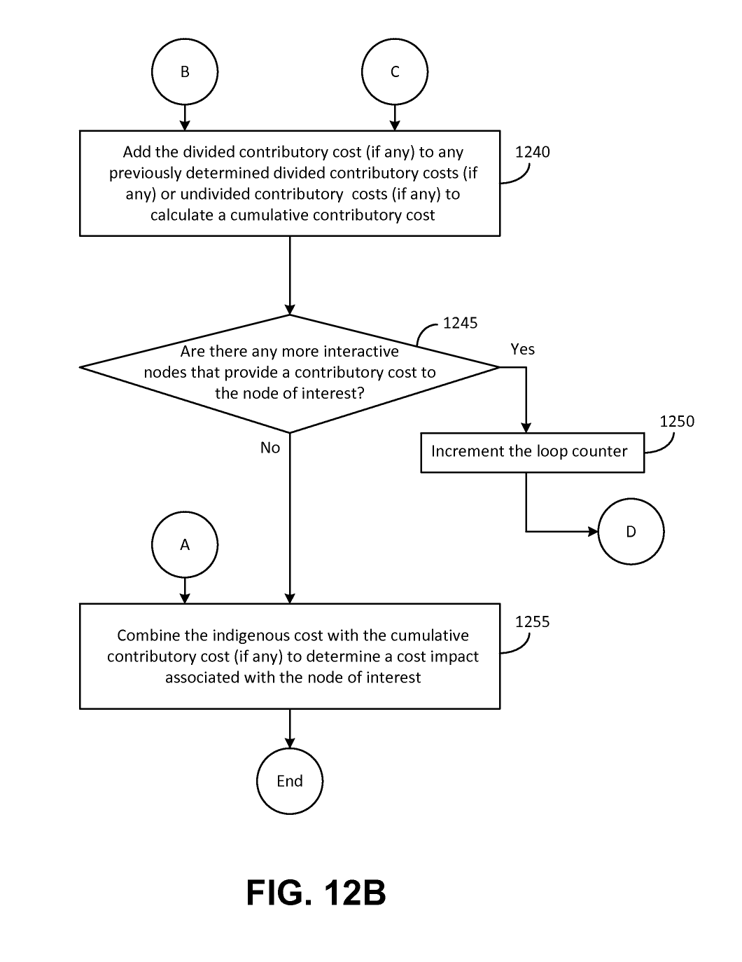

It is to be understood that any method steps or blocks shown in FIG. 11 (as well as in FIGS. 12A-B) may represent modules, segments, or portions of code that include one or more executable instructions for implementing specific logical functions or steps in the method. In certain implementations, one or more of the steps may be performed manually. It will be appreciated that, although particular example method steps are described below, additional steps or alternative steps may be utilized in various implementations without detracting from the spirit of the invention. Moreover, steps may be executed out of order from that shown or discussed, including substantially concurrently or in reverse order, depending on various alternative implementations. Code may be also contained in one or more devices, and may not be necessarily confined to any particular type of device. The explanation below, while possibly implying code residency and functionality in certain devices, does so solely for the purposes of explaining concepts behind the invention, and should not be construed in a limiting manner.

In step 1105, data is retrieved by a first node from a number of nodes. In block 1110, a primary traversal graph is generated using a suitable program incorporating a suitable algorithm (such as Tarjan's algorithm in adapted form or in original form). In block 1115, the primary traversal graph is analyzed to determine if two or more nodes have a circular interdependency. If a circular interdependency is detected, in block 1120, the respective nodes of this circular interdependency are combined to form an strong node (alternatively referred to herein as an integrated node). The formation of the strong node avoids the need to resolve ambiguities associated with the circular interdependency. For example, the CEO in the example described above may not be particularly interested in figuring out how the operating cost issue is resolved in first branch office 820. (The CEO is especially uninterested in how the costs are borne in each of the individual departments in first branch office 820). As long as the CEO's program detects the circular interdependency and suitably adapts to this information (by creating a strong node), the CEO assumes that the branch manager of first branch office 820 will take care of the issue.

In block 1125, a determination is made if more such nodes having a circular interdependency are present in the primary traversal graph. If an additional circular interdependency is detected, the method loops back to block 1120. If no additional circular interdependencies are found, the method proceeds to block 1130, wherein a secondary traversal graph is generated using the integrated nodes as well as any independent nodes that are present. The secondary traversal graph is used to analyze interactions between the various nodes and to calculate a cost impact at any specific node based on indigenous and non-indigenous costs at that specific node. This aspect is described below in more detail using FIGS. 12A-B.

Attention is drawn back to block 1115, wherein if no circular interdependency is detected, the operation flows into block 1130. The secondary traversal graph generated in this case (via this path) is the same as the primary traversal graph because of the absence of any interdependent nodes. Turning back to FIG. 9, it can be recognized that node 9 (computer in customer location 825) is an independent node having no contributory nodes (i.e. no arrows entering node 9).

FIGS. 12A-B show a flow chart indicating various steps that may be implemented for calculating a cost impact in accordance with the invention. In block 1205, a node of interest is identified in a secondary traversal graph. In the example described above using FIG. 10, the node of interest is node 0. (Any node other than node 0 may be selected instead, if so desired).

In block 1210, an indigenous cost associated with the node of interest is determined. The indigenous cost in the example described above vis-a-vis node 0, may be the salary and bonus amount paid to the CEO.

In block 1215, a loop counter is set to a count of one. This loop counter is used to keep track of certain nodes as explained below. In block 1220, a determination is made whether an interactive node is present that provides a contributory cost to the node of interest. The contributory cost is considered herein as a non-indigenous cost associated with the node of interest. For example, with reference to FIG. 10, if the node of interest is strong node 3, there are two interactive nodes that each provides a contributory cost to strong node 3. These two interactive nodes are strong node 2 and node 9. Using this example, in block 1225, a contributory cost from the first contributory node (say strong node 2) is determined. The contributory cost in this case will be provided by a cumulative cost contribution from nodes 6 and 7. It will not be necessary to calculate the individual contributory cost of each of nodes 6 and 7 because of using the concept of a strong node.

In block 1230, a determination is made if strong node 2 provides a contributory cost to nodes other than the node of interest (strong node 3). Strong node 2 does provide a contributory cost to another node—strong node 1. Consequently, in block 1235, the contributory cost of strong node 2 may be divided by 2, or by any other suitable factor.

Thus, in one embodiment, where a contributing node contributes to “N” nodes, the contributory cost to any particular node of interest among these “N” nodes, is calculated by dividing the contributory cost of the contributing node by a numerical value “N” (i.e. an equal division over “N” nodes).

However, in another embodiment, the contributory cost to a particular node of interest among the “N” nodes, is calculated by dividing the contributory cost of the contributing node by a weighted factor. The weighting factor may be determined in various ways. Using the example described above, the contributory cost to strong node 3 (particular node of interest) may be the contributory cost of strong node 2 divided by 0.5 (rather than “2”), and the contributory cost to strong node 1 (another particular node of interest) may be the contributory cost of strong node 2 divided by 2.5. The 0.5 and 2.5 factors may be determined based on any suitable criteria, such as, for example, the relative importance of strong node 3 with reference to strong node 1.

Turning now to FIG. 12B, in block 1240, any of the following costs (when present) are added together to calculate a cumulative contributory cost: i) an undivided contributory cost derived from block 1230, ii) a divided contributory cost derived from block 1235, and iii) additional contributory costs from either block 1230 and/or 1235. The additional contributory costs from block 1230 and/or block 1235 may be present as a result of a loop action that may be generated as a result of block 1245, where a determination is made to find out if any more interactive nodes that provided a contributory cost to the node of interest is present. If such a node is present, in block 1250 the counter is incremented. In a first loop cycle, the loop counter now has a count of two before looping to block 1225 wherein the contributory cost of this additional interactive node is determined. It will be understood that in the example described above (with reference to block 1220) the second interactive node is node 9. The contributory cost calculation for node 9 will follow blocks 1225, 1230 and 1240. Block 1235 will be bypassed because node 9 does not provide contributory costs to any other node other than strong node 3.

In block 1245, if it is determined if any more interactive nodes are present that provide a contributory cost to the node of interest. In the example used above, there will be no additional interactive nodes other than strong node 2 and node 9. As explained, strong node 2 is discovered in first pass of the flow chart with loop count equal to one, and node 9 is discovered in second pass of the flow chart with loop count equal to two.

In block 1255, the cumulative contributory cost (derived from block 1240 and/or block 1220) is combined with an indigenous cost to determine a cost impact associated with the node of interest.

While the examples used with reference to FIGS. 12A-B use monetary values, it will be understood that the cost impact may pertain to non-monetary parameters as well. For example, the cost impact may pertain to determining an employee turnover ratio.

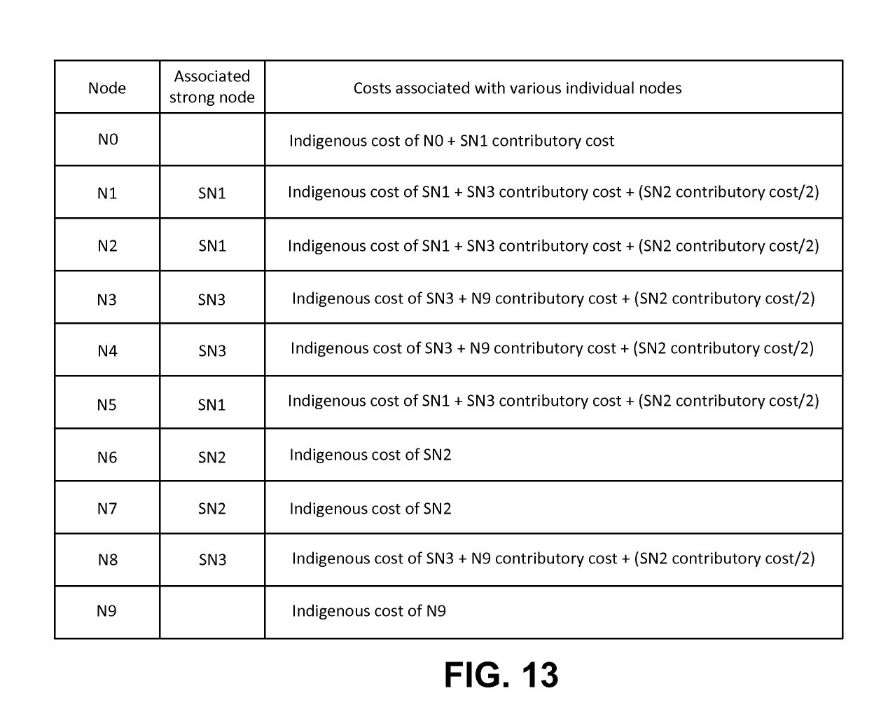

FIG. 13 shows a table that lists costs associated with the various individual nodes shown in FIGS. 9 and 10. The various nodes and strong nodes are designated as Nx and SNx respectively. For example, node 0 is designated NO while strong node 1 is designated SN1.

As can be understood from the two figures, costs associated with NO include the indigenous cost of this node (N0) together with the contributory cost from SN1, which is the only node contributing a non-indigenous cost to NO.

Costs associated with N1 (which is incorporated inside SN1) are determined from the sum of: i) the indigenous cost of SN1, ii) a contributory cost from SN3 (which does not provide contributory costs to any node other than SN1), and iii) a contributory cost from SN2 divided by two (the division by two is a result of SN2 providing contributory costs to two nodes i.e., SN1 and SN3).

Costs associated with N2 and N5 are the same as those for N1 because N2 and N5 are also incorporated into SN1.

Costs associated with N3 (which is incorporated inside SN3) are determined from the sum of: i) the indigenous cost of SN3, ii) a contributory cost from N9 (which is an independent node and does not provide contributory costs to any node other than SN3), and iii) a contributory cost from SN2 divided by two (the division by two is a result of SN2 providing contributory costs to two nodes i.e., SN1 and SN3).

Costs associated with N4 and N8 are the same as those for N3 because N4 and N8 are also incorporated into SN3.

In contrast to the interdependent nodes N0-N8, N9 is an independent node and the only cost associated with this node is the indigenous cost of this node. SN2 also is an independent node that does not derive contributory costs from other nodes (no incoming arrows). Consequently, the costs associated with SN2 (i.e. with each of nodes 6 and 7) are the indigenous costs of SN2.

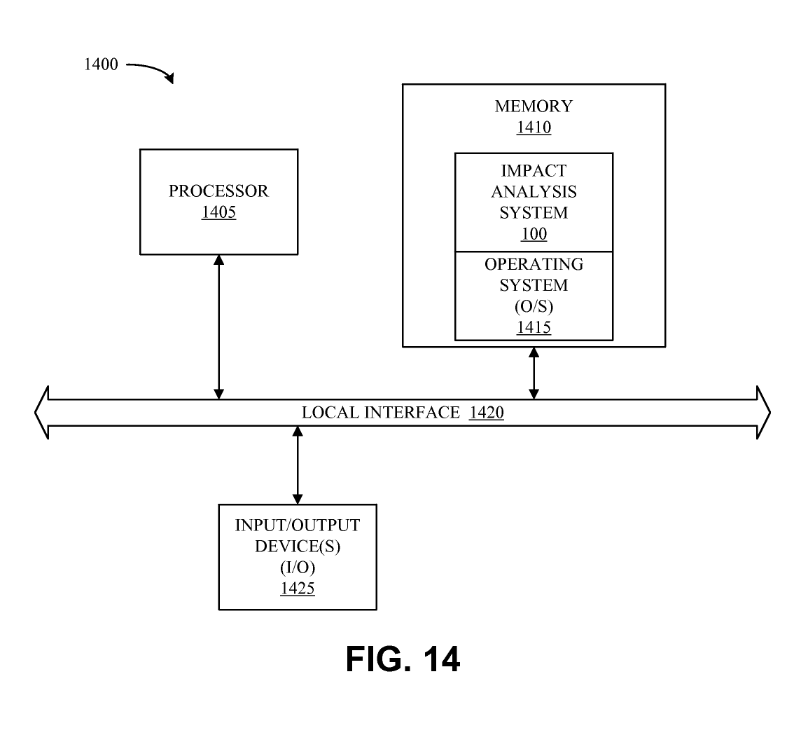

FIG. 14 shows an exemplary computer system 1400 that may be used to implement a system and method of impact analysis in accordance with the invention.

Impact analysis system 100 may be implemented in hardware, software, firmware, or a combination thereof. In the currently contemplated best mode, the impact analysis system 100 is implemented in software, particularly an executable program that is executed in a special or general purpose digital computer, such as a personal computer (PC), a workstation, a minicomputer, or a mainframe computer.

An example of a general purpose computer 1400 that can implement the impact analysis system 100 in accordance with the invention is shown in FIG. 14.

Generally, in terms of hardware architecture, computer 1400 includes a processor 1405, memory 1410, and one or more input/output (I/O) devices 1425 (or peripherals) that are communicatively coupled via a local interface 1420. The local interface 1420 can be, for example but not limited to, one or more buses or other wired or wireless connections, as is known in the art.

The local interface 1420 may have additional elements, which are omitted for simplicity, such as controllers, buffers (caches), drivers, repeaters, and receivers, to enable communications. Further, the local interface 1420 may include address, control, and/or data connections to enable appropriate communications among the aforementioned components.

The processor 1405 is a hardware device for executing software, particularly that stored in memory 1410. The processor 1405 can be any custom made or commercially available processor, a central processing unit (CPU), an auxiliary processor among several processors associated with the computer 1400, a semiconductor based microprocessor (in the form of a microchip or chip set), a macroprocessor, or generally any device for executing software instructions.

The memory 1410 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 1410 may incorporate electronic, magnetic, optical, and/or other types of storage media. Note that the memory 1410 can have a distributed architecture, where various components are situated remote from one another, but can be accessed by the processor 1400.

The software in memory 1410 may include one or more separate programs, each of which comprises an ordered listing of executable instructions for implementing logical functions. In the example of FIG. 14, the software in the memory 1410 includes the impact analysis system 100 in accordance with the invention, and a suitable operating system (O/S) 1415. A nonexhaustive list of examples of suitable commercially available operating systems 1415 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; or (f) an appliance-based operating system, such as that implemented in handheld computers or personal digital assistants (PDAs) (e.g., PalmOS available from Palm Computing, Inc., and Windows CE available from Microsoft Corporation). The operating system 1415 essentially controls the execution of other computer programs, such as the impact analysis system 100, and provides scheduling, input-output control, file and data management, memory management, and communication control and related services.

Impact analysis system 100 may be a source program, an executable program (object code), a script, or any other entity comprising a set of instructions to be performed. When a source program, the program may be translated via a compiler, assembler, interpreter, or the like, which may or may not be included within the memory 1410, so as to operate properly in connection with the O/S 1415. Furthermore, the impact analysis system 100 may be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 1425 may include input devices, for example but not limited to, a keyboard, mouse, scanner, microphone, etc. Furthermore, I/O devices 1425 may also include output devices, for example a printer or a display. Finally, the I/O devices 1425 may also include devices that communicate both inputs and outputs, for instance but not limited to, a modulator/demodulator (modem) for accessing another device, system, or network, a radio frequency (RF) or other transceiver, a telephonic interface, a bridge, or a router.

If the computer 1400 is a PC, workstation, or the like, the software in the memory 1410 may further include a basic input output system (BIOS) (omitted for simplicity). The BIOS is a set of essential software routines that initialize and test hardware at startup, start the O/S 1415, and support the transfer of data among the hardware devices. The BIOS is stored in ROM so that the BIOS can be executed when the computer 1400 is activated.

When the computer 1400 is in operation, the processor 1405 is configured to execute software stored within the memory 1410, to communicate data to and from the memory 1410, and to generally control operations of the computer 1400 pursuant to the software. Impact analysis system 100 and the O/S 1415, in whole or in part, but typically the latter, are read by the processor 1405, perhaps buffered within the processor 1405, and then executed.

When impact analysis system 100 is implemented in software, as is shown in FIG. 14, it should be noted that the impact analysis system 100 can be stored on any computer readable storage medium for use by or in connection with any computer related system or method. In the context of this document, a computer readable storage medium is an electronic, magnetic, optical, or other physical device or means that can contain or store data and/or a computer program for use by or in connection with a computer related system or method.

The impact analysis system 100 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” or “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CD ROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the impact analysis system 100 is implemented in hardware, the impact analysis system 100 can implemented with any or a combination of the following technologies, which are each well known in the art: a discrete logic circuit(s) having logic gates for implementing logic functions upon data signals, an application specific integrated circuit (ASIC) having appropriate combinatorial logic gates, a programmable gate array(s) (PGA), or a field programmable gate array (FPGA).

While the systems and methods have been described by means of specific embodiments and applications thereof, it is understood that numerous modifications and variations could be made thereto by those skilled in the art without departing from the spirit and scope of the disclosure.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances the intended distinction between claim features and description features is underscored by using slightly different terminology.

What is claimed is:

1. An impact analysis system comprising:
an input/output interface operable to:
receive from a first node, a first portion of data comprising a first metric;
receive from a second node, a second portion of data comprising a second metric; and
receive from a third node, a third portion of data comprising a third metric;
a processor operable to:
use the first, second and third portions of received data to generate a primary traversal graph for analyzing interactions between the first, second and third nodes;
use the primary traversal graph to analyze the received first portion of data, and upon detecting that the first metric is an independent metric, designate the first node as an independent node;
use the primary traversal graph to analyze the received second and third portions of data, and upon detecting a circular interdependency comprising the second and third metrics designate a combination of at least the second and third nodes as an integrated node;
generate a secondary traversal graph for analyzing interactions between the independent node and the integrated node; and
use the secondary traversal graph to determine a cost impact associated with at least one of the independent node or the integrated node.

2. The system of claim 1, wherein the cost impact is a monetary cost impact.

3. The system of claim 2, wherein the monetary cost impact is associated with at least one of a material cost, an operational cost, or a development cost of at least one of the first, second or third nodes.

4. The system of claim 3, wherein the at least one of a material cost, an operational cost, or a development cost is associated with at least one of a hardware element or a software product.

5. The system of claim 1, wherein:
the input/output interface and the processor are components of a receiving computing node; and
the first, second and third portions of data are received in the input/output interface of the receiving computing node via a communications network.

6. The system of claim 5, wherein the cost impact comprises a non-indigenous cost impact and an indigenous cost impact, and wherein the processor is further operable to combine the non-indigenous cost impact with the indigenous cost impact to determine a cumulative cost impact that is defined in monetary units.

7. The system of claim 1, wherein the cost impact is a non-monetary cost impact.

8. The system of claim 7, wherein at least one of the first, second and third metrics is associated with an occurrence of at least one event, and wherein the non-monetary cost impact comprises a loss of human life or a potential loss of human life.

9. The system of claim 1, wherein the first metric is associated with a first event occurring at a first instant in time, the second metric is associated with a second event occurring at a second instant in time, and the third metric is associated with a third event occurring at a third instant in time.

10. The system of claim 9, wherein at least two of the first, second and third instants in time are non-concurrent instants.

11. The system of claim 1, wherein using at least one of the primary or the secondary traversal graphs comprises application of Tarjan's algorithm.

12. A computer-readable storage medium having computer-executable instructions for performing the steps of:
analyzing a first portion of data comprising a first metric and determining therefrom, that the first metric is an independent metric;
using the independent metric to determine a first impact parameter;
analyzing a second portion of data comprising a plurality of metrics and detecting a circular interdependency in the plurality of metrics;
based upon the circular interdependency, designating the plurality of metrics as an integrated metric;
using the integrated metric to determine a second impact parameter; and
combining the first impact parameter and the second impact parameter to determine a first cost impact.

13. The computer-readable storage medium of claim 12, wherein the first cost impact is a non-indigenous cost impact upon a first node.

14. The computer-readable storage medium of claim 12, wherein analyzing the received first and second portions of data comprises generation of a primary traversal graph, and further wherein detecting the circular interdependency comprises an analysis of the primary traversal graph.

15. The computer-readable storage medium of claim 14, wherein the integrated metric is indicated as a first strong node in a secondary traversal graph, and wherein determining the first cost impact comprises application of Tarjan's algorithm upon at least one of the primary or the secondary traversal graphs.

16. The computer-readable storage medium of claim 15, wherein each of the first metric and the plurality of metrics is defined in monetary units.

17. The computer-readable storage medium of claim 16, wherein the monetary units are associated with at least one of a material cost, an operational cost, or a development cost of at least one of a hardware element or a software product.

18. The computer-readable storage medium of claim 15, wherein using the integrated metric to determine the second impact parameter comprises using a first portion of the integrated metric, and further comprising:
using a second portion of the integrated metric to determine a second cost impact parameter in a second strong node.

19. The computer-readable storage medium of claim 18, wherein the first and second portions of the integrated metric are equal to each other.

20. The computer-readable storage medium of claim 15, wherein using the integrated metric to determine the second impact parameter comprises using a 1/N portion of the integrated metric (N>1), with the remaining (N−1)/N portions of the integrated metric shared equally amongst (N−1) other nodes.

21. The computer-readable storage medium of claim 15, wherein using the integrated metric to determine the second impact parameter comprises using a 1/N portion of the integrated metric (N≠0), with the remaining (N−1)/N portions of the integrated metric shared unequally amongst (N−1) other nodes.

22. A method of impact analysis, comprising:
receiving in a computer, a first portion of data comprising a first metric;
receiving in the computer, a second portion of data comprising a second metric; and
receiving in the computer, a third portion of data comprising a third metric;
analyzing the received first portion of data and determining that the first metric is an independent metric;
analyzing the received second and third portions of data and detecting a circular interdependency comprising the second and third metrics;
upon detecting the circular interdependency, designating a combination of at least the second and third metrics as an integrated metric;
using the independent metric to determine a first impact parameter;
using the integrated metric to determine a second impact parameter; and
combining the first and second impact parameters to determine a first cost impact.

23. The method of claim 22, wherein analyzing the received first, second and third portions comprises generation of a primary traversal graph, and further wherein detecting the circular interdependency between the second and third metrics comprises an analysis of the generated primary traversal graph.

24. The method of claim 23, further comprises generation of a secondary traversal graph that includes a strong node defined at least in part by the second and third metrics, and wherein the analysis of at least one of the primary or the secondary traversal graphs comprises application of Tarjan's algorithm.
